(19) United States
(12) Patent Application Publication
(10) Pub. No.: US 2011/0229845 A1
(43) Pub. Date: Sep. 22, 2011

(54) ULTRASONIC DENTAL IMPLANT TOOL SET

(76) Inventor: Chun-Leon CHEN, Changhua City (TW)

(21) Appl. No.: 12/725,832

(22) Filed: Mar. 17, 2010

(51) Int. Cl. A61C 1/07

(52) U.S. Cl. 433/86

(57) ABSTRACT

An ultrasonic dental implant tool set includes an ultrasonic machine, a hand piece connected to the ultrasonic machine and tool members selectively mounted on the hand piece for providing vibrations and a compressed fluid. Each tool member has a connection base, a pole and a cutter tip. The spray nozzle has a connection base, a pole extends from the connection base and having a longitudinal fluid passage for the passing of a fluid and a fluid injection hole for injecting a fluid into a vertical hole made on the alveolar ridge of the patient to be treated, and an operating tip located on one end of the pole remote from the connection base and for insertion into the vertical hole made on the alveolar bone of the patient to transfer ultrasonic vibrations to the fluid applied to the inside of the vertical hole on the alveolar bone of the patient.

### BACKGROUND OF THE INVENTION

1. Field of the Invention

The present invention relates to medical instruments for use in dental implant surgery and more particularly, to an ultrasonic dental implant tool set, which facilitates the performance of dental implant surgery.

2. Description of the Related Art

During a dental implant surgery, an implant root is implanted in the alveolar bone, and then an abutment is affixed to the implant root, and then a crown is affixed to the abutment. Prior to implant of the implant root in the alveolar bone, an osteotomy must be performed on the alveolar bone. At this time, drill bit means used to make a round hole on the alveolar bone relatively smaller than the diameter of the implant root so that the implant root can be tightly mounted in the alveolar bone.

However, the alveolar bone has a relatively thinner area at the molar area adjacent to the sinus where a dental implant surgery is difficult to be performed. In this area, the bone density is low. Dental implant at this area is risky and difficult. Many technical reports regarding dental implant in this area have been extensively discussed. Due to fast development of graft materials (bone powders), the prevent inventor disclosed a hydraulic sinus condensing technique to enhance dental implant stability in this thinner alveolar bone.

Conventionally, a dental implant surgery is achieved subject to the use of a dental implant tool set. Basically, a dental implant tool set includes an electric or electromagnetic vibration generator and a hand piece connected to the electric or electromagnetic vibration generator for transferring vibrations. The hand piece can be selectively attached with one of a series of tips to achieve the desired dental implant surgery.

US Patent Application Publication No. 2009/0004624 A1, entitled “Piezo Insert and Piezo Packer for Operating an Implant Surgical Operation Using Piezoelectric Device”, teaches the use of a piezoelectric device. As shown in FIG. 1, the piezoelectric device comprises a piezoelectric main device 10, a hand piece 20, a piezo insert 30 and a piezo packer 40.

Subject to the statement in [0029] of the specification, the piezo insert 30 and the piezo packer 40 are mounted in the hand piece 20 of the piezoelectric main device 10 so that electric vibration generated by the piezoelectric main device 10 is transmitted to the piezo insert 30 and the piezo packer 40, thereby converting into mechanical vibration for the performance of the dental implant surgery.

According to the aforesaid prior art design, the vibration force is attenuated during transfer through the operating tools (the piezo insert 30 and the piezo packer 40), affecting the performance of the dental implant surgery. When using ultrasonic waves to transmit a vibration force, the operating tools may produce heat, affecting the performance of the dental implant surgery. Due to this problem, no any ultrasonic dental implant tool set design is commercially available.

### SUMMARY OF THE INVENTION

The present invention has been accomplished under the circumstances in view. It is therefore the main object of the present invention to provide an ultrasonic dental implant tool set, which facilitates the performance of a dental implant surgery.

To achieve this and other objects of the present invention, an ultrasonic dental implant tool set comprises an ultrasonic machine, a hand piece connected to the ultrasonic machine by a cord, and tool members selectively mounted on the hand piece for providing vibrations and a compressed fluid. Each tool member comprises a connection base that has one end thereof connectable to the hand piece, a pole that extends from an opposite end of the connection base and has a longitudinal fluid passage extending through two distal ends thereof for the passing of the compressed fluid provided by the ultrasonic machine and a fluid injection hole for ejecting the compressed fluid provided by the ultrasonic machine into a vertical hole made on the alveolar bone of a patient, and an operation tip located on one end of the pole remote from the connection base and for insertion into the hole made on the alveolar bone of the patient to transfer ultrasonic vibrations to the hole to break soft tissues of the patient.

Further, a cooling fluid passage may be made on the junction between the connection base and pole of each tool member for the passing of a cooling fluid to cool down the temperature.

Because the invention provides ultrasonic waves to the operating tip of the attached tool member through the hand piece to vibrate the applied fluid during the performance of a dental implant surgery, the problem of attenuation of vibration during transfer as seen in the prior art design is eliminated in the present invention. Therefore, the invention is much better than the conventional piezoelectric device or any other electromagnetic vibrators, facilitating the performance of a dental implant surgery. Further, any heat produced during transfer of ultrasonic waves through the tool member is soon cooled down by a cooling fluid passing through the cooling fluid passage.

The features of the present invention will be understood in details by way of embodiments of the present invention in conjunction with the appended drawings.

### BRIEF DESCRIPTION OF THE DRAWINGS

FIG. 1 is a schematic drawing showing the outer appearance of an ultrasonic dental implant tool set in accordance with the present invention.

FIG. 2 is a schematic drawing showing the tool member of the ultrasonic dental implant tool set inserted into the alveolar bone of a patient and operated.

FIG. 3 is an elevational view of an alternate form of the tool member for ultrasonic dental implant tool set in accordance with the present invention.

FIG. 4 is a sectional view of the tool member shown in FIG. 3.

FIG. 5 is an elevational view of another alternate form of the tool member for ultrasonic dental implant tool set in accordance with the present invention.

FIG. 6 is a longitudinal sectional view of the tool member shown in FIG. 5.

FIG. 7 is a sectional plain view of the operating tip of the tool member shown in FIG. 5.

FIG. 8 is an elevational view of still another alternate form of the tool member for ultrasonic dental implant tool set in accordance with the present invention.

FIG. 9 is a longitudinal sectional view of the tool member shown in FIG. 8.

FIG. 10 is a sectional plain view of the operating tip of the tool member shown in FIG. 8.

FIG. 11 is an elevational view of still another alternate form of the tool member for ultrasonic dental implant tool set in accordance with the present invention.

FIG. 12 is a longitudinal sectional view of the tool member shown in FIG. 11.

FIG. 13 is a sectional plain view of the operating tip of the tool member shown in FIG. 11.

FIG. 14 is a perspective view of still another alternate form of the tool member for ultrasonic dental implant tool set in accordance with the present invention.

FIG. 15 is a longitudinal sectional view of the tool member shown in FIG. 14.

FIG. 16 is a sectional plain view of the operating tip of the tool member shown in FIG. 14.

FIG. 17 is an elevational view of still another alternate form of the tool member for ultrasonic dental implant tool set in accordance with the present invention.

FIG. 18 is a longitudinal sectional view of the tool member shown in FIG. 17.

FIG. 19 is an elevational view of still another alternate form of the tool member for ultrasonic dental implant tool set in accordance with the present invention.

FIG. 20 is a longitudinal sectional view of the tool member shown in FIG. 19.

FIG. 21 is an elevational view of still another alternate form of the tool member for ultrasonic dental implant tool set in accordance with the present invention.

FIG. 22 is a longitudinal sectional view of the tool member shown in FIG. 21.

### DETAILED DESCRIPTION OF THE PREFERRED EMBODIMENT

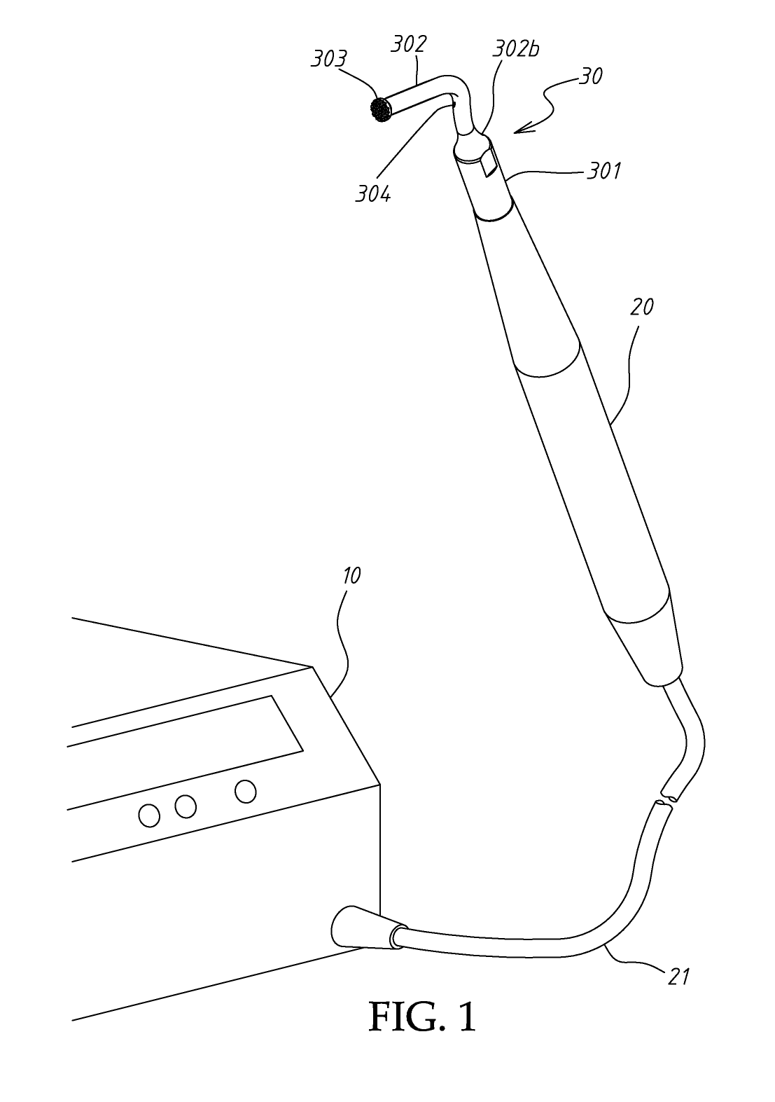

Referring to FIG. 1, an ultrasonic dental implant tool set in accordance with the present invention is shown comprising an ultrasonic machine 10, an ultrasonic hand piece 20 and a tool member 30.

The ultrasonic machine 10 is adapted for generating ultrasonic vibrations and providing a flow of compressed fluid. The hand piece 20 is connected to the ultrasonic machine 10 by a cord 21 for transferring the ultrasonic vibrations and the flow of compressed fluid.

The tool member 30 may be designed subject to different functions. Basically, the tool member 30 has a connection base 301 that has its one end configured for connection to the hand piece 20, a L-shaped pole 302 extended from the other end of the connection base 301 and defining therein a longitudinal fluid passage for the passing of the flow of compressed fluid and a fluid injection hole 304 for guiding the flow of compressed fluid into a vertical hole on the alveolar bone of the patient, and an operating tip 303 located on the other end of the L-shaped pole 302 remote from the connection base 301 for enabling the ultrasonic vibrations to be converted into mechanical vibrations. The tool member 30 further has a cooling fluid passage 302b located on the junction between the connection base 301 and the pole 302 for the passing of a cooling fluid.

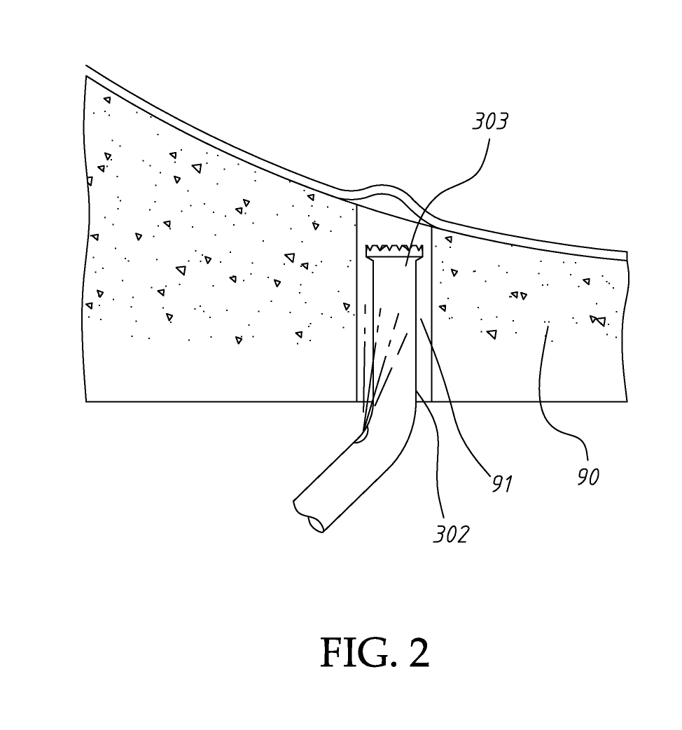

Referring to FIG. 2, when the operating tip 303 is inserted into a vertical hole 91 on the alveolar bone 90 of a patient, a jet of the compressed fluid is guided out of the fluid injection hole 304 into the inside of the vertical hole 91 and vibrated by ultrasonic waves to break soft tissues, facilitating the performance of the dental implant surgery.

Because the invention provides ultrasonic waves to the operating tip 303 of the tool member 30 to vibrate the applied fluid, the problem of attenuation of vibration during transfer as seen in the prior art design is eliminated in the present invention. Therefore, the invention is much better than the conventional piezoelectric device or any other electromagnetic vibrators, facilitating the performance of a dental implant surgery. Further, any heat produced during transfer of ultrasonic waves through the tool member 30 is soon cooled down by a cooling fluid passing through the cooling fluid passage 302b.

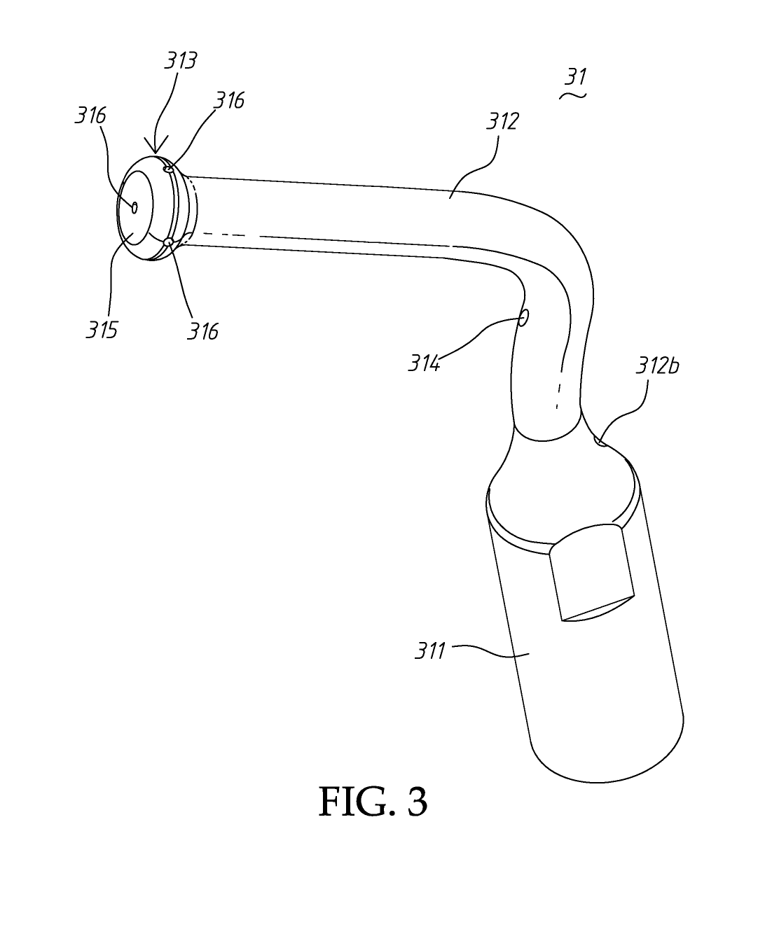

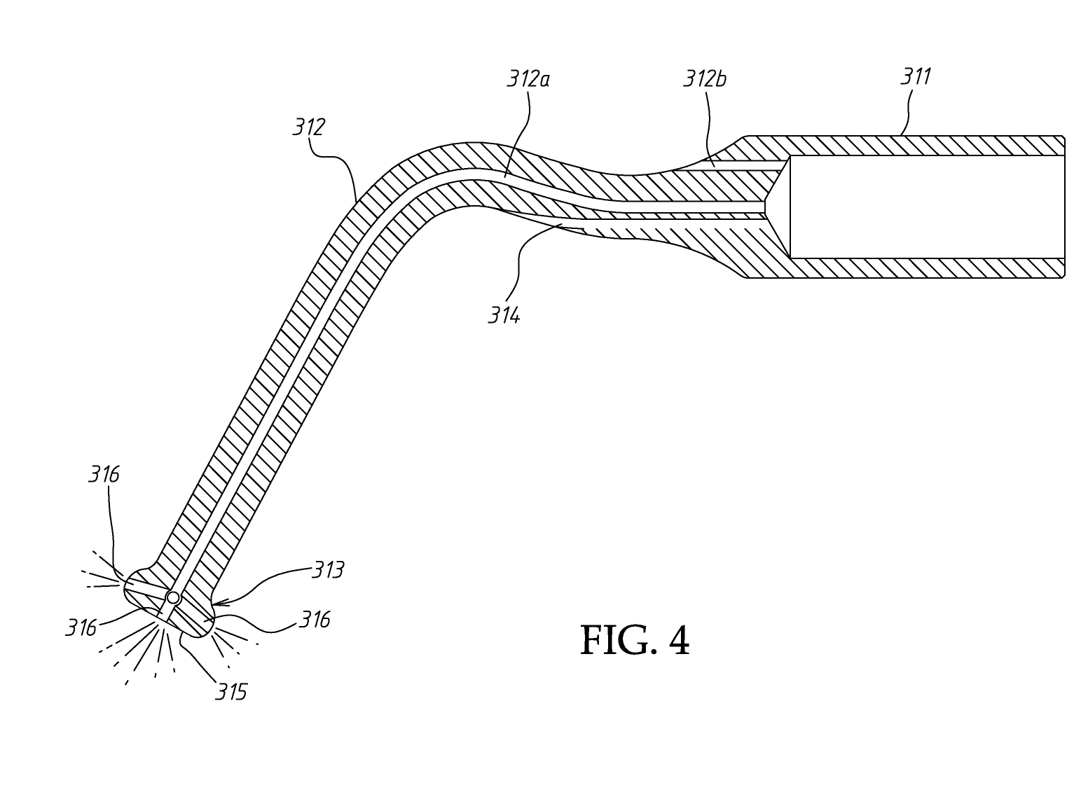

Referring to FIGS. 3 and 4, the tool member, referenced by 31, is designed for separating the sinus membrane. As illustrated, the tool member 31 has a connection base 311 that has its one end configured for connection to the hand piece 20, a L-shaped pole 312 extended from the other end of the connection base 311 and defining therein a longitudinal fluid passage 312a for the passing of a compressed fluid and a fluid injection hole 314 for guiding a compressed fluid into a vertical hole 91 on the alveolar bone of a patient, an operating tip 313 located on the other end of the L-shaped pole 312 remote from the connection base 311 for separating the sinus membrane and for enabling ultrasonic vibrations to be converted into mechanical vibrations, a cooling fluid passage 312b located on the junction between the connection base 311 and the pole 312 for the passing of a cooling fluid, and a plurality of jet holes 316 located on the center of the end face 315 of the operating tip 313 and equiangularly spaced around the periphery of the operating tip 313 in communication with the longitudinal fluid passage 312a for guiding out a compressed fluid radially in jets.

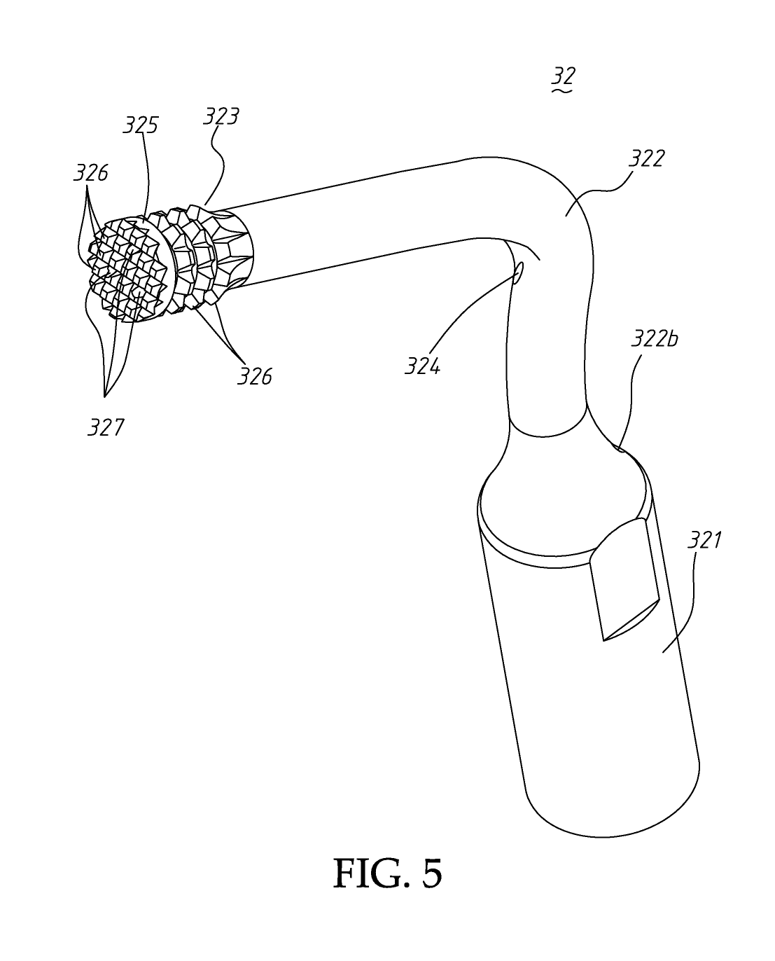

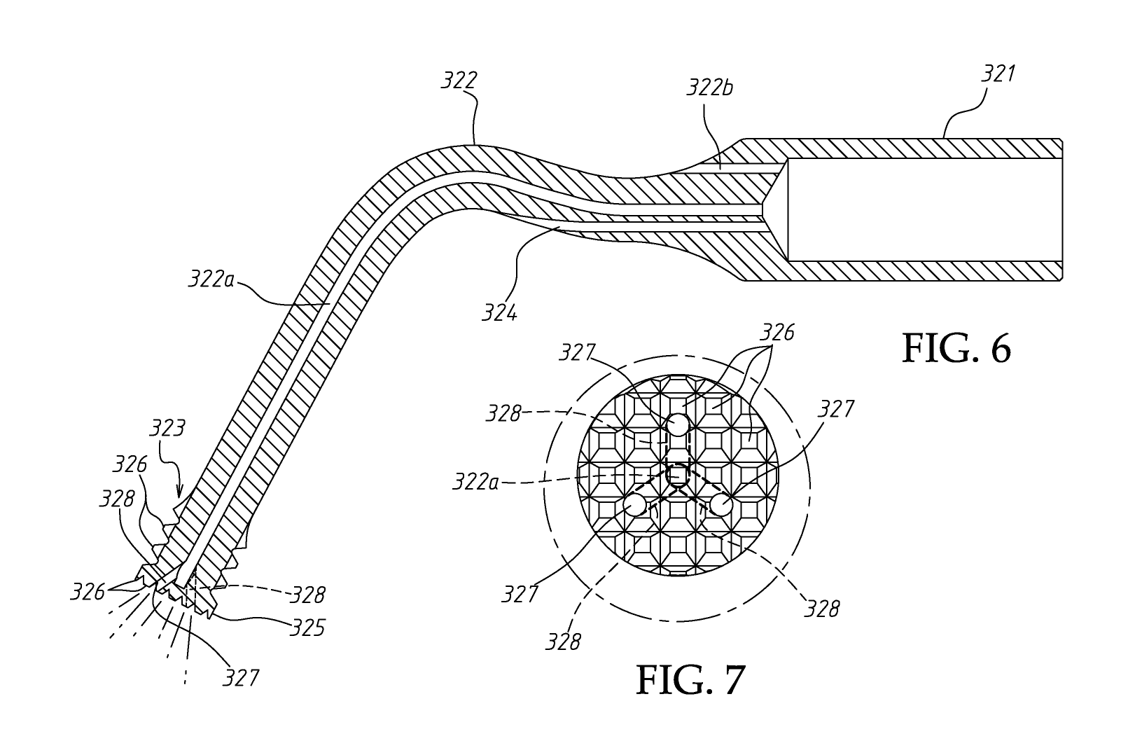

Referring to FIGS. 5˜7, the tool member, referenced by 32, is a cutter tip designed for separating the sinus membrane. As illustrated, the tool member 32 has a connection base 321 that has its one end configured for connection to the hand piece 20 (see also FIG. 1), a L-shaped pole 322 extended from the other end of the connection base 321 and defining therein a longitudinal fluid passage 322a for the passing of a compressed fluid and a fluid injection hole 324 for guiding a compressed fluid into a vertical hole 91 on the alveolar bone of a patient (see also FIG. 2), an operating tip 323 located on the other end of the L-shaped pole 322 remote from the connection base 321 for separating the sinus membrane and for enabling ultrasonic vibrations to be converted into mechanical vibrations, and a cooling fluid passage 322b located on the junction between the connection base 321 and the pole 322 for the passing of a cooling fluid. Further, the operating tip 323 is a cylindrical member having a plurality of protruding cutting edges 326 raised from the end face 325 and the periphery thereof for cutting the alveolar bone and producing vibrations to fill a bone powder in a vertical hole made on the patient's alveolar bone during the dental implant surgery, three jet holes 327 equiangularly spaced on the end face 325, and three oblique manifolds 328 respectively connected between the fluid passage 322a and the jet holes 327 for enabling a compressed fluid to be driven out of the end face 325 radially in jets.

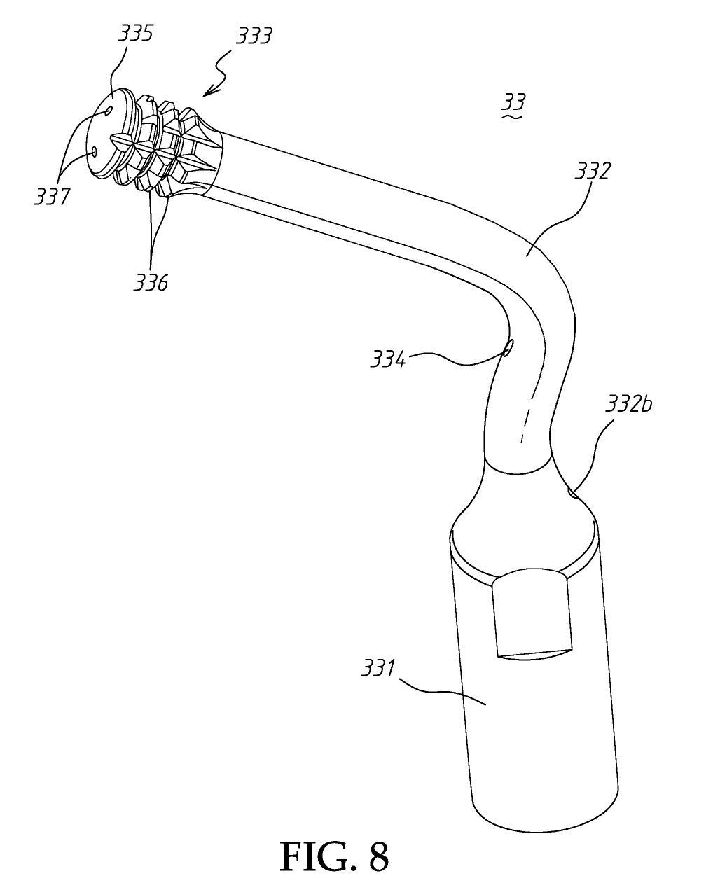

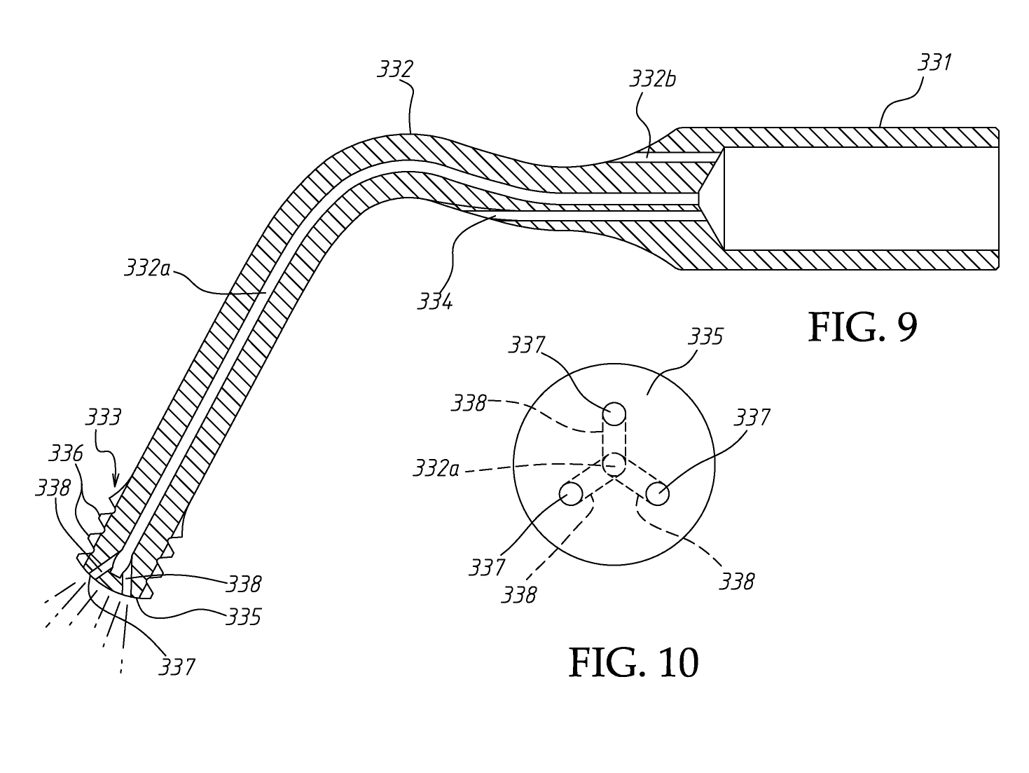

Referring to FIGS. 8˜10, the tool member, referenced by 33, is a cutter tip designed for separating the sinus membrane. As illustrated, the tool member 33 has a connection base 331 that has its one end configured for connection to the hand piece 20 (see also FIG. 1), a L-shaped pole 332 extended from the other end of the connection base 331 and defining therein a longitudinal fluid passage 332a for the passing of a compressed fluid and a fluid injection hole 334 for guiding a compressed fluid into a vertical hole 91 on the alveolar bone of a patient (see also FIG. 2), an operating tip 333 located on the other end of the L-shaped pole 332 remote from the connection base 331 for separating the sinus membrane and for enabling ultrasonic vibrations to be converted into mechanical vibrations, and a cooling fluid passage 332b located on the junction between the connection base 331 and the pole 332 for the passing of a cooling fluid. Further, the operating tip 333 is a cylindrical member having a plurality of protruding cutting edges 326 raised from the periphery thereof for cutting the alveolar bone and producing vibrations to fill a bone powder in a vertical hole made on the patient's alveolar bone during the dental implant surgery, three jet holes 337 equiangularly spaced on the planar end face 335, and three oblique manifolds 338 respectively connected between the fluid passage 332a and the jet holes 337 for enabling a compressed fluid to be driven out of the end face 335 radially in jets.

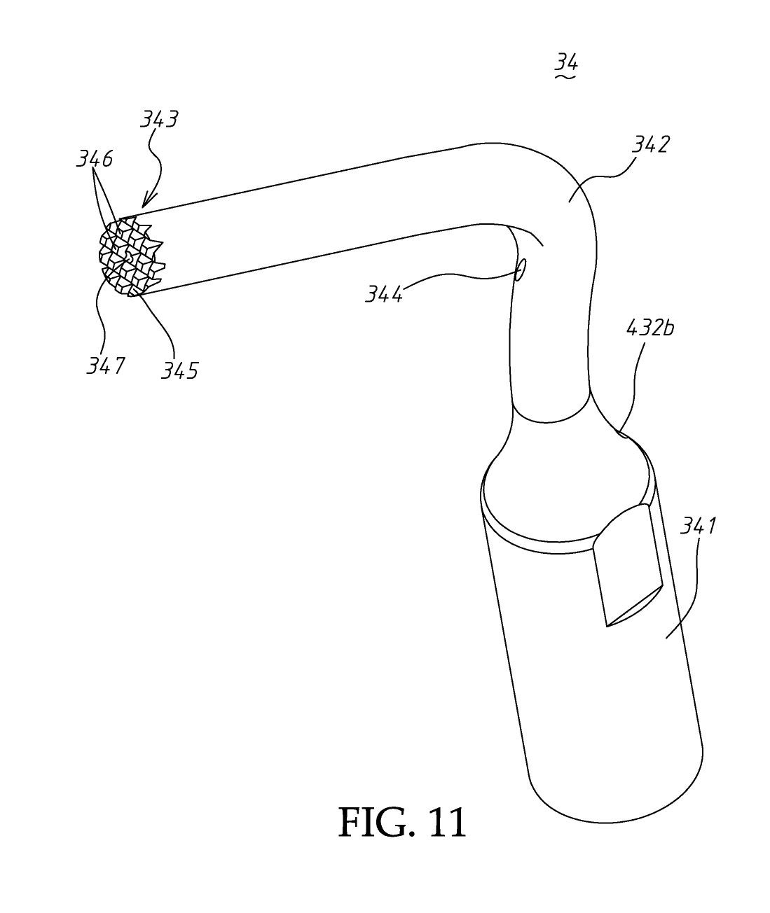

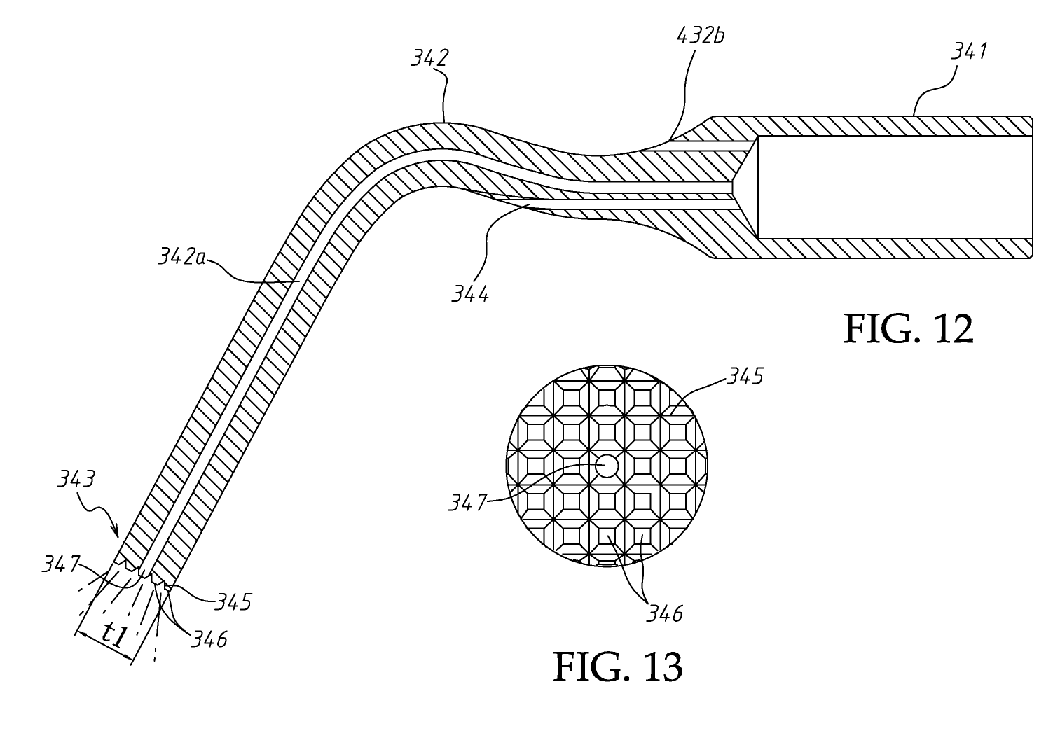

Referring to FIGS. 11˜13, the tool member, referenced by 34, is designed for compacting the applied bone powder. As illustrated, the tool member 34 has a connection base 341 that has its one end configured for connection to the hand piece 20 (see also FIG. 1), a L-shaped pole 342 extended from the other end of the connection base 341 and defining therein a longitudinal fluid passage 342a for the passing of a compressed fluid and a fluid injection hole 344 for guiding a compressed fluid into a vertical hole 91 on the alveolar bone of a patient (see also FIG. 2), an operating tip 343 located on the other end of the L-shaped pole 342 remote from the connection base 341 for compacting the applied bone powder, and a cooling fluid passage 342b located on the junction between the connection base 341 and the pole 342 for the passing of a cooling fluid. Further, the operating tip 343 has a plurality of protruding cutting edges 346 raised from the end face 345 and a jet hole 347 located on the center of the end face 345 in communication with the fluid passage 342a. The end face 345 has a diameter t1 about 1.8 mm.

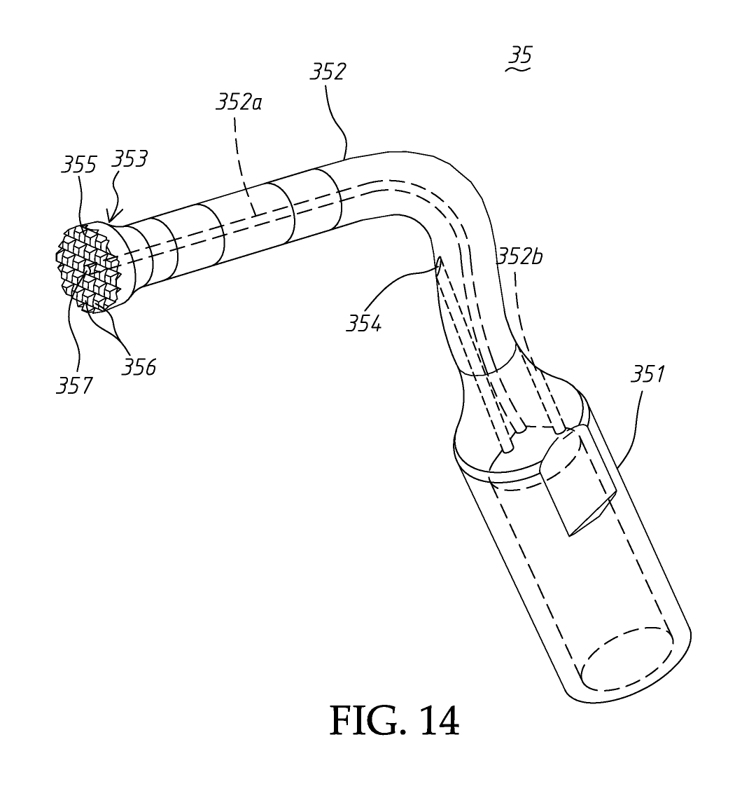

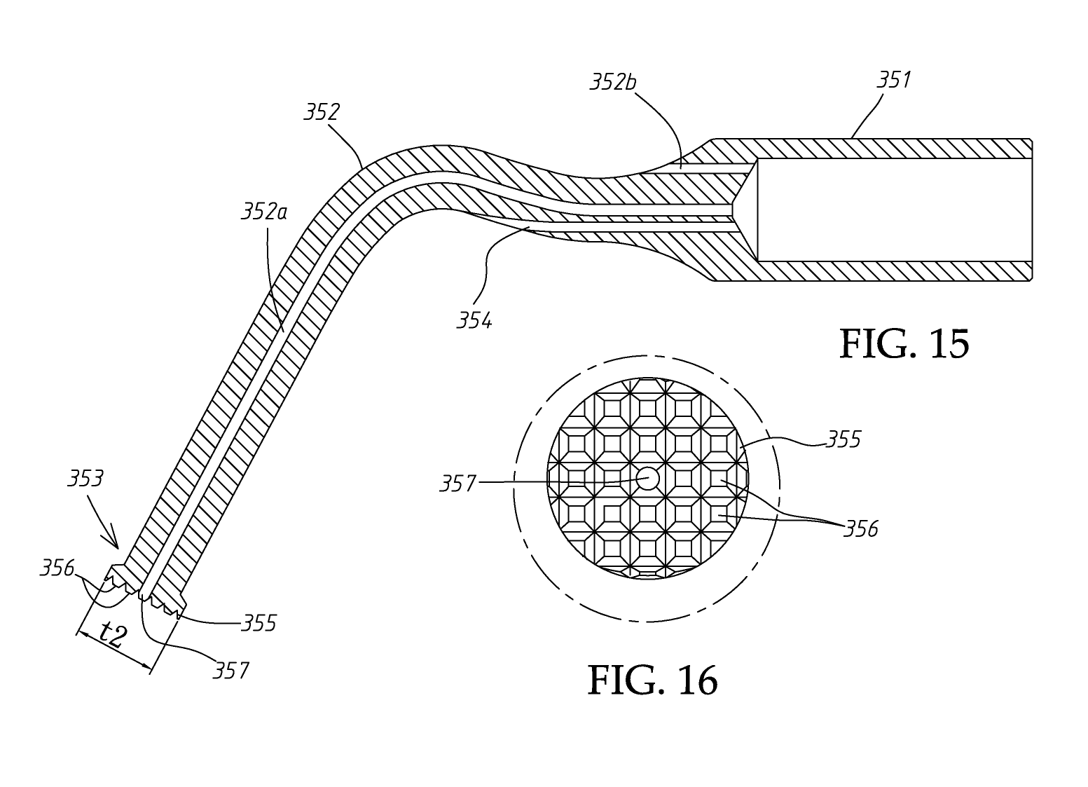

Referring to FIGS. 14˜16, the tool member, referenced by 35, is designed for compacting the applied bone powder. As illustrated, the tool member 35 has a connection base 351 that has its one end configured for connection to the hand piece 20 (see also FIG. 1), a L-shaped pole 352 extended from the other end of the connection base 351 and defining therein a longitudinal fluid passage 352a for the passing of a compressed fluid and a fluid injection hole 354 for guiding a compressed fluid into a vertical hole 91 on the alveolar bone of a patient (see also FIG. 2), an operating tip 353 located on the other end of the L-shaped pole 352 remote from the connection base 351 for compacting the applied bone powder, and a cooling fluid passage 352b located on the junction between the connection base 351 and the pole 352 for the passing of a cooling fluid. Further, the operating tip 353 has a plurality of protruding cutting edges 356 raised from the end face 355 and a jet hole 357 located on the center of the end face 355 in communication with the fluid passage 352a. The end face 355 has a diameter t2 about 2.8 mm.

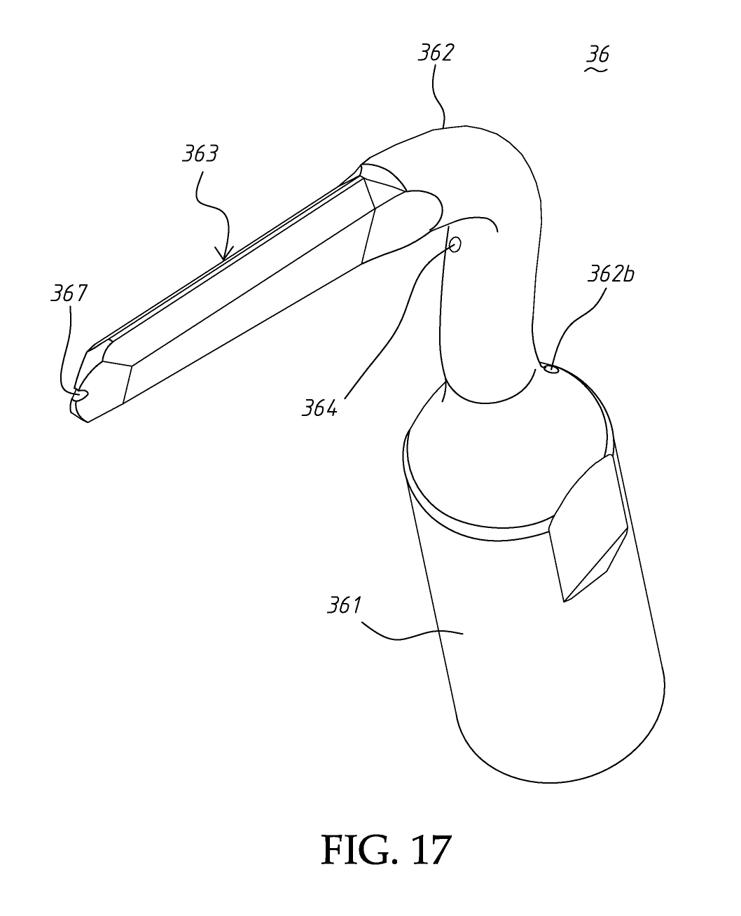

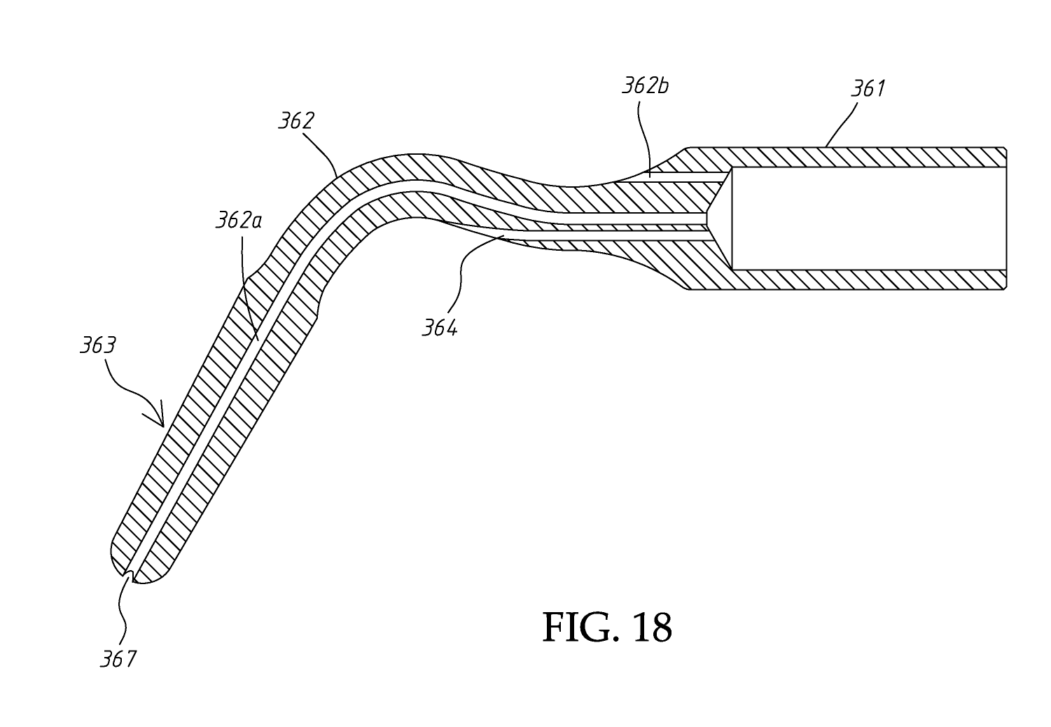

Referring to FIGS. 17 and 18, the tool member, referenced by 36, has a connection base 361 that has its one end configured for connection to the hand piece 20 (see also FIG. 1), a L-shaped pole 362 extended from the other end of the connection base 361 and defining therein a longitudinal fluid passage 362a for the passing of a compressed fluid and a fluid injection hole 364 for guiding a compressed fluid into a vertical hole 91 on the alveolar bone of a patient (see also FIG. 2), an operating tip 363 located on the other end of the L-shaped pole 362 remote from the connection base 361, and a cooling fluid passage 362b located on the junction between the connection base 361 and the pole 362 for the passing of a cooling fluid. Further, the operating tip 363 is shaped like a narrow elongated cutting bar for cutting the periodontal ligament, having a jet hole 367 located on the free end thereof in communication with the fluid passage 362a.

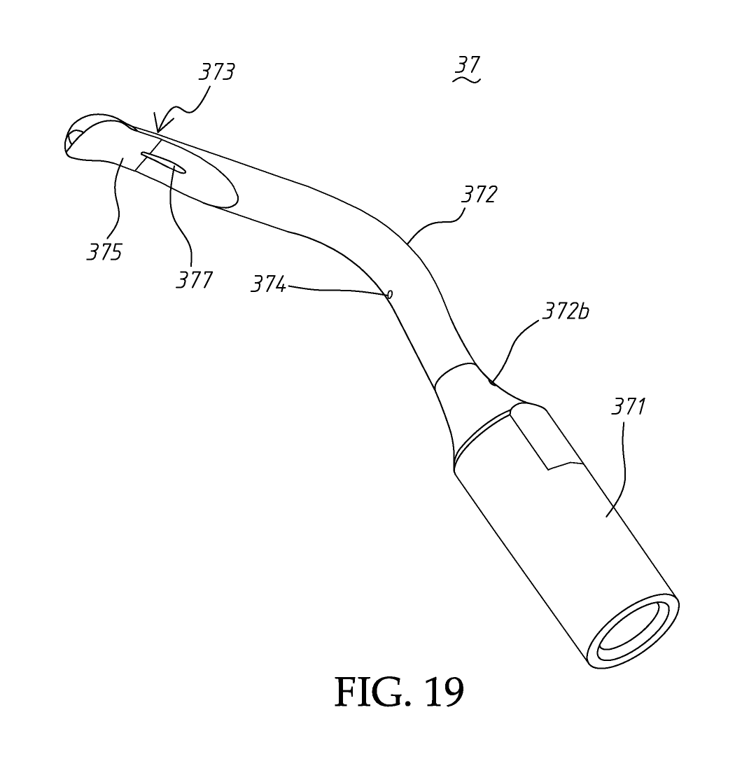

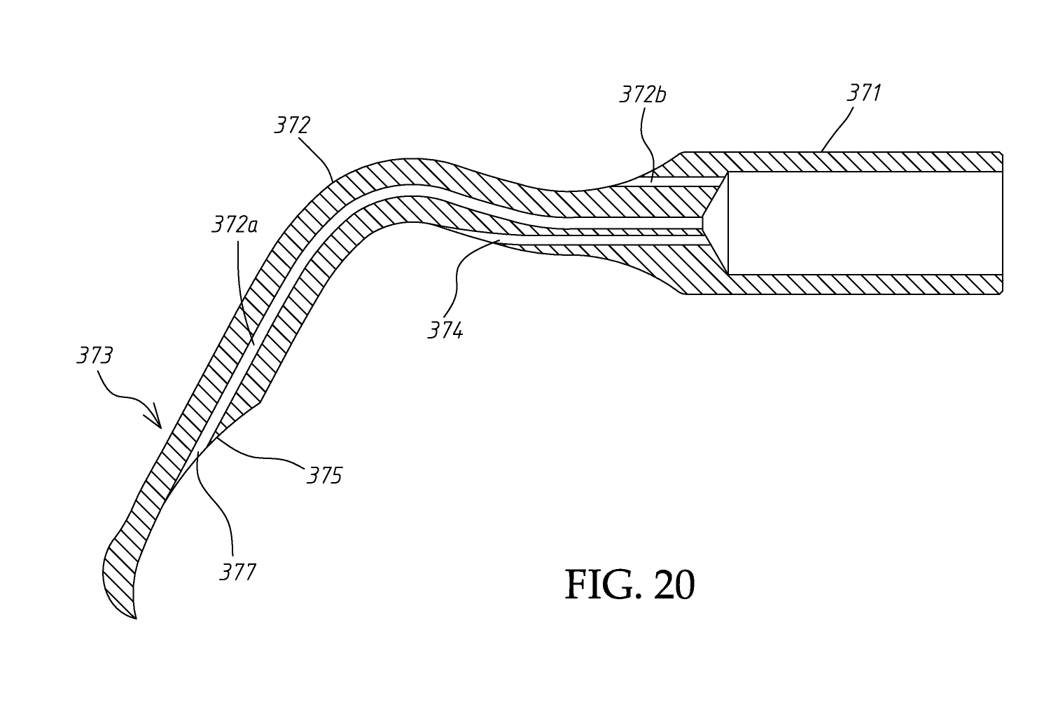

Referring to FIGS. 19 and 20, the tool member, referenced by 37, has a connection base 371 that has its one end configured for connection to the hand piece 20 (see also FIG. 1), a L-shaped pole 372 extended from the other end of the connection base 371 and defining therein a longitudinal fluid passage 372a for the passing of a compressed fluid and a fluid injection hole 374 for guiding a compressed fluid into a vertical hole 91 on the alveolar bone of a patient (see also FIG. 2), an operating tip 373 located on the other end of the L-shaped pole 372 remote from the connection base 371, and a cooling fluid passage 372b located on the junction between the connection base 371 and the pole 372 for the passing of a cooling fluid. Further, the operating tip 373 is a hooked tip having an inwardly curved end face 375 for insertion into the vertical hole 91 on the alveolar bone of the patient to remove waste tissues, and a jet hole 377 located on the inwardly curved end face 375 in communication with the fluid passage 372a.

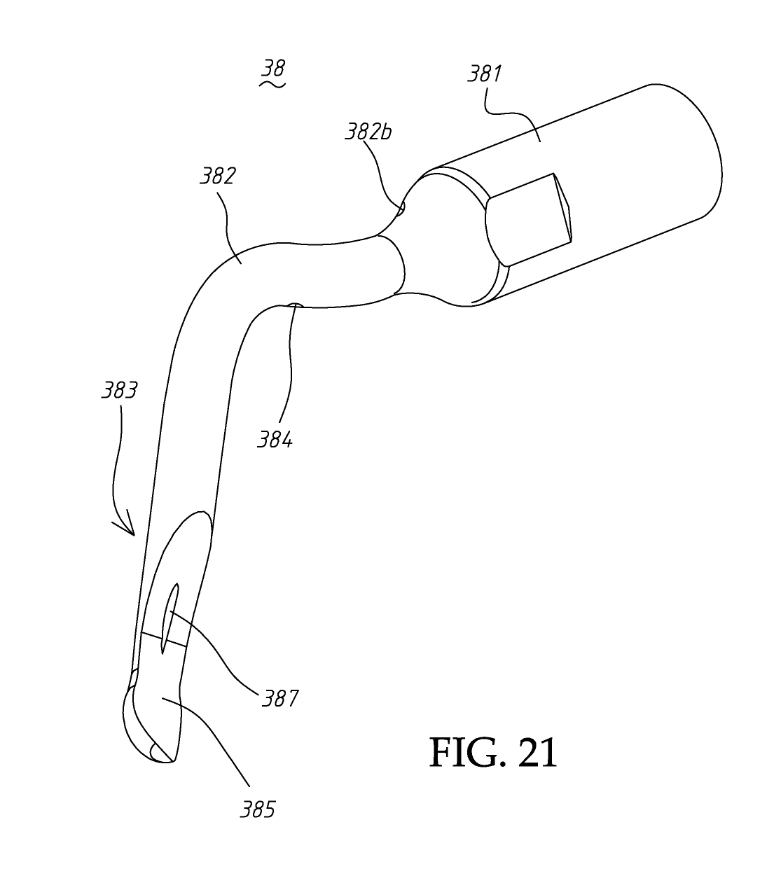

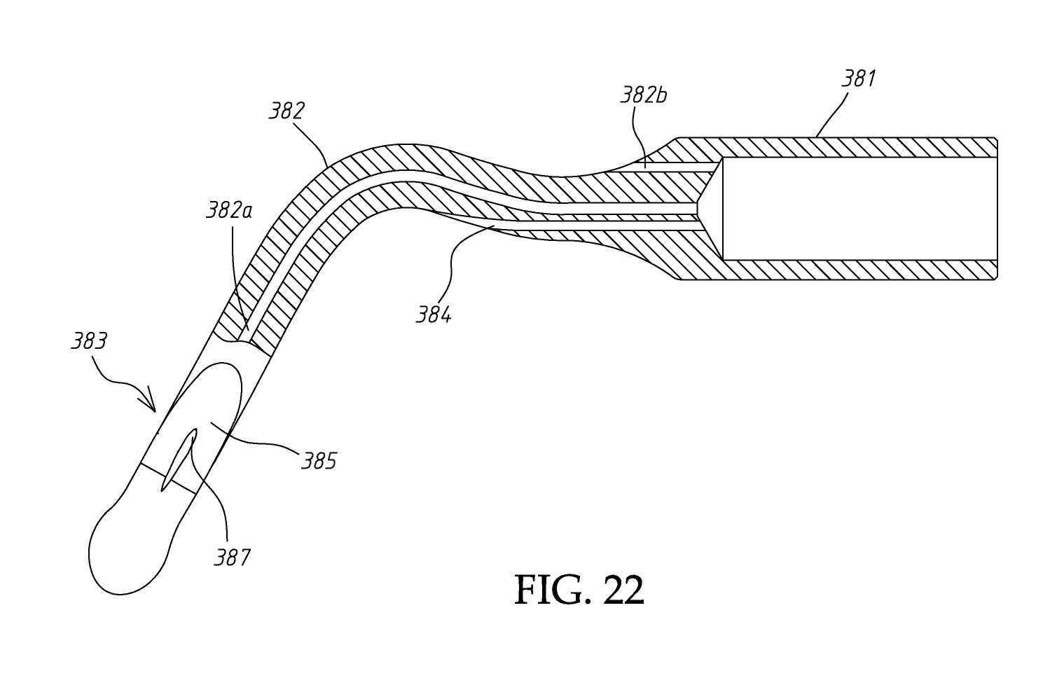

Referring to FIGS. 21 and 22, the tool member, referenced by 38, has a connection base 381 that has its one end configured for connection to the hand piece 20 (see also FIG. 1), a L-shaped pole 382 extended from the other end of the connection base 381 and defining therein a longitudinal fluid passage 382a for the passing of a compressed fluid and a fluid injection hole 384 for guiding a compressed fluid into a vertical hole 91 on the alveolar bone of a patient (see also FIG. 2), an operating tip 383 located on the other end of the L-shaped pole 382 remote from the connection base 381, and a cooling fluid passage 382b located on the junction between the connection base 381 and the pole 382 for the passing of a cooling fluid. Further, the operating tip 383 is hooked tip having an inwardly curved end face 385 for insertion into the vertical hole 91 on the alveolar bone of the patient to remove waste tissues, and a jet hole 387 located on the inwardly curved end face 385 in communication with the fluid passage 382a. The tool member 38 of this alternate form is substantially similar to that shown in FIGS. 19 and 20 with the exception that the inwardly curved end face 375 is biased leftwards

Although particular embodiment of the invention have been described in detail for purposes of illustration, various modifications and enhancements may be made without departing from the spirit and scope of the invention. Accordingly, the invention is not to be limited except as by the appended claims.

What the invention claimed is:

1. An ultrasonic dental implant tool set, comprising:
an ultrasonic machine for generating ultrasonic vibrations and providing a compressed fluid;
a hand piece connected to said ultrasonic machine for transferring the ultrasonic vibration and compressed fluid from said ultrasonic machine;
a tool member, said tool member comprising a connection base, said connection base having one end thereof connectable to said hand piece, a pole extended from an opposite end of said connection base, said pole having a longitudinal fluid passage extending through two distal ends thereof for the passing of the compressed fluid provided by said ultrasonic machine and a fluid injection hole for ejecting the compressed fluid provided by said ultrasonic machine into a vertical hole made on the alveolar bone of a patient, and an operation tip located on one end of said pole remote from said connection base and for insertion into the hole made on the alveolar bone of the patient to transfer ultrasonic vibrations to the hole to break soft tissues of the patient.

2. The ultrasonic dental implant tool set as claimed in claim 1, wherein said tool member further comprises a cooling fluid passage located on the junction between said connection base and said pole for the passing of a cooling fluid to cool down the temperature.

3. The ultrasonic dental implant tool set as claimed in claim 2, wherein said operating tip of said tool member is adapted for separating the sinus membrane, having a plurality of jet holes located on the center of an end face and the periphery thereof in communication with said longitudinal fluid passage for guiding out the compressed fluid provided by said ultrasonic machine radially in jets

4. The ultrasonic dental implant tool set as claimed in claim 2, wherein said operating tip of said tool member is a cylindrical member having a plurality of protruding cutting edges raised from an end face and the periphery thereof for cutting the alveolar bone and producing vibrations to fill a bone powder in the vertical hole made on the alveolar bone of the patient during the dental implant surgery, three jet holes equiangularly spaced on the end face, and three oblique manifolds respectively connected between said longitudinal fluid passage and said jet holes for guiding out the compressed fluid provided by said ultrasonic machine radially in jets to separate the sinus membrane.

5. The ultrasonic dental implant tool set as claimed in claim 2, wherein said operating tip of said tool member is a cylindrical member having a plurality of protruding cutting edges raised from the periphery thereof for cutting the alveolar bone and producing vibrations to fill a bone powder in the vertical hole made on the alveolar bone of the patient during the dental implant surgery, three jet holes equiangularly spaced on an end face thereof, and three oblique manifolds respectively connected between said longitudinal fluid passage and said jet holes for guiding out the compressed fluid provided by said ultrasonic machine radially in jets to separate the sinus membrane.

6. The ultrasonic dental implant tool set as claimed in claim 2, wherein said operating tip of said tool member is adapted for compacting an applied bone powder in the vertical hole made on the alveolar bone of the patient, having a jet hole located on the center of an end face thereof in communication with said longitudinal fluid passage and a plurality of cutting edges raised from the end face, said operating tip having a diameter about 1.8 mm.

7. The ultrasonic dental implant tool set as claimed in claim 2, wherein said operating tip of said tool member is adapted for compacting an applied bone powder in the vertical hole made on the alveolar bone of the patient, having a jet hole located on the center of an end face thereof in communication with said longitudinal fluid passage and a plurality of cutting edges raised from the end face, said operating tip having a diameter about 2.8 mm.

8. The ultrasonic dental implant tool set as claimed in claim 2, wherein said operating tip of said tool member is shaped like a narrow elongated cutting bar adapted for cutting the periodontal ligament, having a jet hole located on the free end thereof in communication with said fluid passage.

9. The ultrasonic dental implant tool set as claimed in claim 2, wherein said operating tip of said tool member is a hooked tip having an inwardly curved end face for insertion into the vertical hole on the alveolar bone of the patient to remove waste tissues, and a jet hole located on said inwardly curved end face in communication with said longitudinal fluid passage.

10. The ultrasonic dental implant tool set as claimed in claim 2, wherein said operating tip of said tool member is a hooked tip having an inwardly curved end face biased leftwards from the axis thereof for insertion into the vertical hole on the alveolar bone of the patient to remove waste tissues, and a jet hole located on said inwardly curved end face in communication with said longitudinal fluid passage.

11. The ultrasonic dental implant tool set as claimed in claim 1, wherein said pole of said tool member has an L-shaped configuration.
